(19) United States
(12) Patent Application Publication
(10) Pub. No.: US 2021/0053698 A1
(43) Pub. Date: Feb. 25, 2021

(54) LUGGAGE TRANSPORT CART WITH POLYMER CABIN

(71) Applicant: FAST Global Solutions, Inc., Glenwood, MN (US)

(72) Inventors: John HOEPER, Alexandria, MN (US); Tim SWENSON, Glenwood, MN (US); Corey W. CLAUSSEN, Benson, MN (US); Jesse HAHNE, Elk River, MN (US); Marc McCAULEY, Elk River, MN (US)

(21) Appl. No.: 16/970,604

(22) PCT Filed: Feb. 19, 2019
(86) PCT No.: PCT/US2019/018557

§ 371 Date: Aug. 17, 2020

Related U.S. Application Data
(60) Provisional application No. 62/632,703, filed on Feb. 20, 2018.
(60) Provisional application No. 62/639,292, filed on Mar. 6, 2018.
(60) Provisional application No. 62/739,518, filed on Oct. 1, 2018.

(51) Int. Cl. B64F 1/32; B60D 1/01; B60D 1/145; B62D 25/06; B62D 25/20; B62D 29/04; B60Q 1/00; B60Q 1/50; H02S 10/40; H02S 40/38; F21S 9/03; F21V 23/04

(52) U.S. Cl. CPC B64F 1/324; B60D 1/01; B60D 1/145; B62D 25/06; B62D 25/2036; B62D 29/043; F21Y 2115/10; B60Q 1/0088; B60Q 1/50; H02S 10/40; H02S 40/38; F21S 9/035; F21V 23/04; B60Q 1/0076

(57) ABSTRACT

A luggage transport cart with a cabin made primarily out of a polymer. In some embodiments, the luggage cart includes an inwardly sloping floor and shelf to help contain the luggage. The floor and shelf may further include ribs and grooves to reduce drag on items disposed thereon, as well as to assist in draining away incident precipitation. The ribs and grooves may be inclined toward the centers of the floor and shelf, with reliefs formed at the junction of inclined surfaces to channel precipitation liquid out of the luggage cart. In some embodiments, the cabin includes backlit panels for enhanced display effects during ambient darkness or semi-darkness. The backlit panels may be sourced by a battery that recharges during daylight hours via a solar panel.

### RELATED APPLICATIONS

This application claims the benefit of U.S. Provisional Patent Application No. 62/632,703 filed Feb. 20, 2018, U.S. Provisional Patent Application No. 62/639,292 filed Mar. 6, 2018, and U.S. Provisional Patent Application No. 62/739,518 filed Oct. 1, 2018, the disclosures of which are hereby incorporated by reference herein in their entirety.

### FIELD OF THE DISCLOSURE

The field of this disclosure relates generally to ground transport carts, and more specifically to luggage carts for ground transport of airline luggage.

### BACKGROUND

Luggage carts are utilized for transporting baggage between airport terminals and aircraft. These devices are typically made of metal, which is subject to corrosion (e.g., rust), thus requiring periodic maintenance (painting) in order to prevent structural damage and to maintain an acceptable appearance. Typical luggage carts feature metallic panels that are often subject to denting and scratching during the rigors of use. The metals used in the construction of luggage carts is relatively heavy, expensive, and require limited and expensive fabrication techniques. Light metals, such as aluminum and aluminum alloys, alleviate some of the weight concern, but tend to dent easily.

A baggage transport cart that remedies the deficiencies of the standard metallic transport cart would be welcome.

### SUMMARY OF THE DISCLOSURE

Various embodiments of the disclosure include a transport cart having a cabin fabricated primarily of polymer materials. Polymer materials are corrosion resistant, resilient to avoid dents, and of homogenous material through its thickness to render scratches inconsequential. In addition, polymer cabins can be fabricated to be lightweight and inexpensive when compared with metallic counterparts. The transport cart includes features that help cradle the luggage under transport toward the center of the cart to prevent inadvertent roll out of items from the transport cart. Structure is also included to channel away precipitation that may otherwise accumulate within the transport during inclement weather.

Various embodiments of the transport cart include a battery that is passively charged by a solar array when exposed to ambient. The energy stored in the battery may be used to source backlit signs (e.g., advertisements or airline logos) during evening or twilight conditions, or to provide lighting to the interior of the polymer cabin. In some embodiments, the light sourcing may be selectively activated, for example by baggage handling personnel.

Structurally, various embodiments of a baggage cart for transporting items between airport terminals and aircraft is disclosed. The baggage cart includes a running gear assembly including rotatable forward wheel assembly operatively coupled to a tow bar, a rearward wheel assembly, and a rearward hitch, and a polymer cabin supported by the running gear. The polymer cabin includes a floor and a roof separated by a forward end wall and a rearward end wall. In some embodiments, the floor includes an upper panel having a first lateral portion and a second lateral portion separated by a relief portion. The relief portion may extend from proximate the forward end wall to proximate the rearward end wall. The first lateral portion of the upper panel of the floor extends from the relief portion to a first lateral edge portion of the floor in a first lateral direction. The second lateral portion of the upper panel of the floor extending from the relief portion to a second lateral edge portion of the floor in a second lateral direction, the second lateral direction being opposite the first lateral direction. In some embodiments, the first lateral portion of the upper panel of the floor slopes downward from the first lateral edge to the relief portion, and the second lateral portion of the upper panel of the floor slopes downward toward the relief portion. The relief portion may extending below the first lateral portion and the second lateral portion of the upper panel of the floor, the relief portion at least partially defining a drain hole.

In some embodiments, the first lateral portion of the upper panel of the floor defines a plurality of ribs and grooves that extend parallel to each other from the relief portion in the first lateral direction, and the second lateral portion of the upper panel of the floor defines a plurality of ribs and grooves that extend parallel to each other from the relief portion in the second lateral direction. The first lateral portion of the upper panel of the floor may also defines a first gutter that extends adjacent and parallel to the first lateral edge portion of the floor from proximate the forward end wall to proximate the rearward end wall, and the second lateral portion of the upper panel of the floor may also define a second gutter that extends adjacent and parallel to the second lateral edge portion of the floor from proximate the forward end wall to proximate the rearward end wall. In some embodiments, the upper panel at each of the first gutter and the second gutter defines a plurality of mounting features for mounting a curtain assembly.

In various embodiments of the disclosure, a shelf is suspended above the floor, the shelf extending from the forward end wall to the rearward end wall. The shelf includes an upper panel having a first lateral portion and a second lateral portion separated by a relief portion. The relief portion may extend from proximate the forward end wall to proximate the rearward end wall, The first lateral portion of the upper panel of the shelf extends from the relief portion to a first lateral edge portion of the shelf in the first lateral direction, and the second lateral portion of the upper panel of the shelf extends from the relief portion to a second lateral edge portion of the shelf in the second lateral direction. In some embodiments, the first lateral portion of the upper panel of the shelf slopes downward toward the relief portion, the second lateral portion of the upper panel of the shelf slopes downward toward the relief portion, the relief portion extending below the first lateral portion and the second lateral portion of the upper panel of the shelf. The relief portion may at least partially defining a drain hole. In some embodiments, the first lateral portion of the upper panel of the shelf defines a plurality of ribs and grooves that extend parallel to each other from the relief in the first lateral direction, and the second lateral portion of the upper panel of the shelf defines a plurality of ribs and grooves that extend parallel to each other from the relief in the second lateral direction.

In various embodiments of the disclosure, a luggage cart for transporting luggage on an airport tarmac is disclosed, the luggage cart including a running gear assembly and a polymer cabin supported by the running gear assembly. The polymer cabin includes a floor coupled to the running gear assembly and having a forward end portion and a rearward end portion, a forward end wall disposed at the forward end portion of the floor, a rearward end wall disposed at the rearward end portion of the floor, and a roof that spans the forward end wall and the rearward end wall. The floor, the forward end wall, the rearward end wall, and the roof defines an opening on a lateral side of the polymer cabin. The floor may include an upper panel having a first lateral portion and a second lateral portion separated by a relief portion, the first lateral portion and the second lateral portion each defining a plurality of ribs and grooves that extend parallel to each other and laterally from the relief portion. In some embodiments, the plurality of ribs and grooves each define an inclined angle relative to the forward end portion and the rearward end portion of the floor, the inclined angle sloping downward toward the relief portion. The floor may define a drain hole that passes through the relief portion. In some embodiments, the upper panel of the floor defines a pair of gutters, each extending proximate a lateral edge portion of a respective one of the first lateral portion and the second lateral portion of the floor, each of the pair of gutters extending below the lateral edge portion. Each of the pair of gutters defines a drain hole that passes therethrough.

In some embodiments, the luggage cart includes a shelf suspended above the floor and having a forward end portion that is coupled to the forward end wall and a rearward end portion that is coupled to the rearward end wall, the shelf including an upper panel having a first lateral portion and a second lateral portion separated by a relief portion, the first lateral portion and the second lateral portion of the shelf each defining a plurality of ribs and grooves that extend parallel to each other and laterally from the relief portion of the shelf. The plurality of ribs and grooves of the shelf may each define an inclined angle relative to the forward end portion and the rearward end portion of the shelf, the inclined angle of the shelf sloping downward toward the relief portion of the shelf.

Various embodiments of the disclosure also include a lighting system including a solar panel connected to a battery via a battery tender, the battery being in selective communication with a timer and a light emitter via a push button switch, the timer being configured to energize the light emitter for a selected interval of time that is initiated by activating the push button switch, the solar panel being mounted to the roof, the push button switch being mounted inside the polymer cabin and accessible from outside the polymer cabin. The battery may be mounted to the running gear. The push button switch may be mounted to an upright extending upward from the running gear. In some embodiments, a backlit panel is coupled to the roof, the backlit panel including a translucent material, the light emitter of the lighting system configured to backlight the backlit panel. The backlit panel may be configured, for example, with at least one of an advertisement and a corporate logo. The backlit panel may be one of an upright edge billboard, an upright center billboard, and a portion of an exterior panel of the roof.

Various embodiments of the disclosure include a method of displaying a backlit sign on an airport tarmac. The method may include instructing baggage handling personnel to perform the steps of: positioning a luggage cart adjacent an aircraft on an airport tarmac; activating a lighting system installed on the luggage cart after the step of positioning the luggage cart; and

one of unloading the luggage from the aircraft onto the luggage cart and loading the luggage from the luggage cart to the aircraft after the step of activating the lighting system. For the method, the lighting system is configured to backlight a panel disposed on the luggage cart for a fixed time period after the step of activating the lighting system

### BRIEF DESCRIPTION OF THE DRAWINGS

FIG. 1 is an upper perspective view of a luggage cart according to an embodiment of the disclosure;

FIG. 2 is the luggage cart of FIG. 1 without an enclosure curtain assembly according to an embodiment of the disclosure;

FIG. 3 is a side perspective view of the luggage cart of FIG. 2 according to an embodiment of the disclosure;

FIG. 4 is a lower perspective view of the luggage cart of FIG. 2 according to an embodiment of the disclosure;

FIG. 5 is an upper perspective view of a running gear assembly of e luggage cart of FIG. 1 according to an embodiment of the disclosure;

FIG. 6 is a lower perspective view of a gear assembly of the luggage cart of FIG, 1 according to an embodiment of the disclosure;

FIG. 7 is an isolated, upper perspective view of a floor of the luggage cart of FIG. 1 according to an embodiment of the disclosure;

FIG. 8 is an isolated, lower perspective view of the floor of FIG. 7 according to an embodiment of the disclosure;

FIG. 9 is a perspective sectional view of the floor of FIG. 7 at plane IX-IX according to an embodiment of the disclosure;

FIG. 10 is a perspective sectional view of the floor of FIG. 7 at plane X-X according to an embodiment of the disclosure;

FIG. 11 is a partial, enlarged view of the perspective sectional view of FIG. 10 according to an embodiment of the disclosure;

FIG. 12 is an isolated, upper perspective view of an end wall of the luggage cart of FIG. 1 according to an embodiment of the disclosure;

FIG. 13 is a lower perspective view of the end wall of FIG. 12 according to an embodiment of the disclosure;

FIG. 14 is an isolated, upper perspective view of an roof of the luggage cart of FIG. 1 according to an embodiment of the disclosure;

FIG. 15 is a lower perspective view of the roof of FIG. 14 according to an embodiment of the disclosure;

FIG. 15A is an enlarged, exploded view of a portion of FIG. 15 according to an embodiment of the disclosure;

FIG. 16 is an electrical schematic of a lighting system for t luggage carts of FIGS. 1 and 23 through 26 according to embodiments of the disclosure.

FIG. 17 is an isolated, upper perspective view of a shelf of the luggage cart of FIG. 2 according to an embodiment of the disclosure;

FIG. 18 is an isolated, lower perspective view of the shelf of FIG. 17 according to an embodiment of the disclosure;

FIG. 19 is a perspective sectional view of the shelf of FIG. 17 at plane XIX-XIX according to an embodiment of the disclosure;

FIG. 20 is a partial, enlarged view of the perspective sectional view of FIG. 19 according to an embodiment of the disclosure;

FIG. 21 is an isolated, perspective view of a curtain assembly of the luggage cart of FIG. 1 according to an embodiment of the disclosure;

FIG. 22 is a partial, enlarged view of the perspective view of FIG. 21 according to an embodiment of the disclosure;

FIG. 23 is an upper perspective view of a luggage cart having backlit upright edge billboards according to an embodiment of the disclosure;

FIG. 24 is an upper perspective view of a luggage cart having a backlit upright center billboard according to an embodiment of the disclosure;

FIG. 25 is an upper perspective view of a luggage cart having a roof with exterior backlit portions according to an embodiment of the disclosure; and

FIG. 26 are perspective views representing luggage carts with activated backlight panels according to an embodiment of the disclosure.

### DETAILED DESCRIPTION OF THE FIGURES

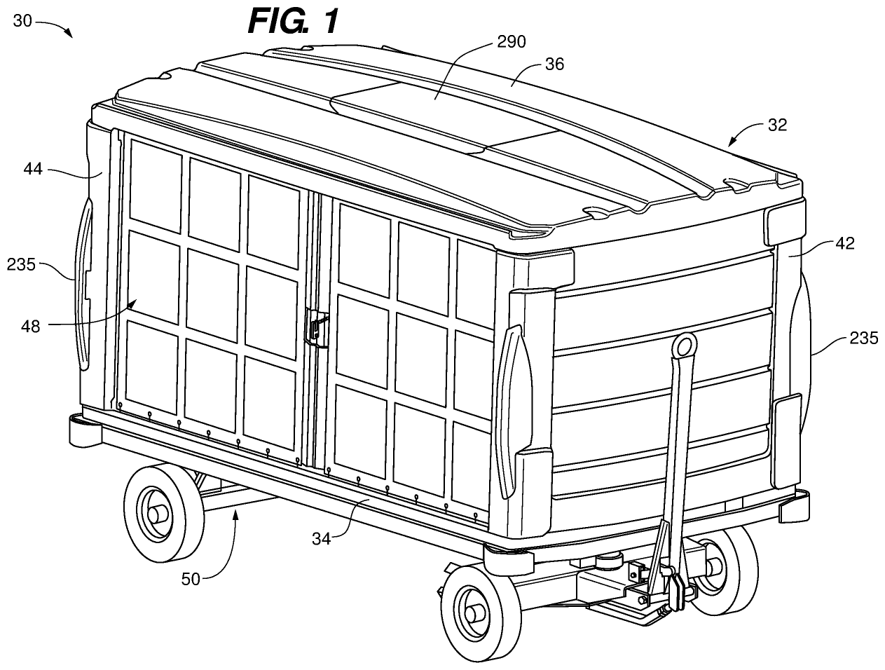

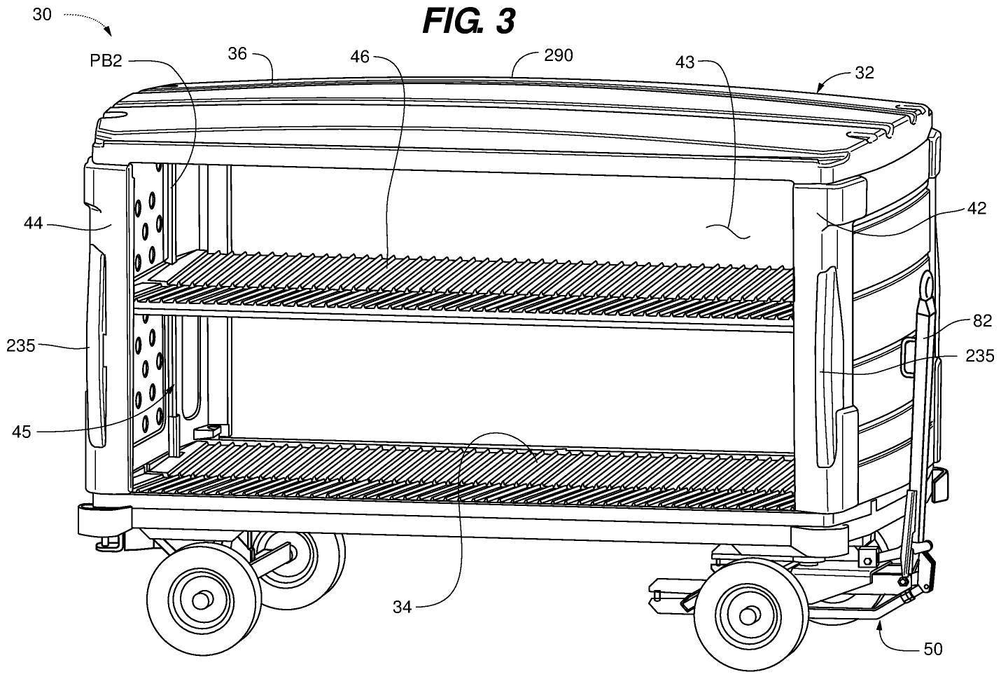

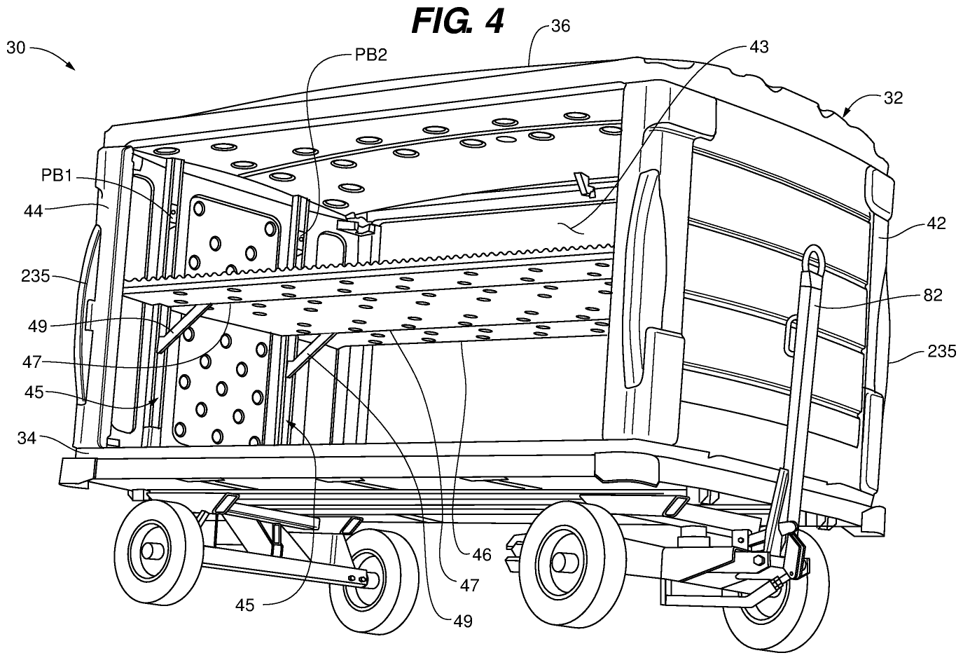

Referring to FIGS. 1 through 4, a luggage cart 30 is depicted according to an embodiment of the disclosure. The luggage cart 30 includes a cabin 32 having a floor 34 and a roof 36 separated by two end walk 42 and 44, the floor 34, roof 36, and end walls 42 and 44 defining at least one opening 43 on a lateral side of the cabin 32. In some embodiments, a shelf 46 is suspended over the floor 34 by and between the end walls 42 and 44. The shelf 46 may be supported by uprights 45 and a pair of shelf stringers 47 extend longitudinally between the uprights 45 (FIG. 4). Gusset brackets 49 may be coupled to each upright 45, and extend beneath or within the shelf 46 to support the ends of the shelf stringers 47. In some embodiments, the cabin 32 is outfitted with a curtain assembly 48 that substantially covers the opening(s) 43 for shrouding the interior of the cabin 32. The cabin 32 is operatively coupled to a running gear assembly 50.

The floor 34, roof 36, end walls 42, 44, and shelf 46 may be made of a polymer material, for example by a rotomolding process. These components may also be of a modular construction, formed separately and shipped unassembled with the roof 36 and end walls 42, 44 stacked on the running gear assembly 50 to an end user for final assembly. In this way, the shipping volume of the units is substantially reduced relative to an assembled unit, for compactness and economy during shipping and storage.

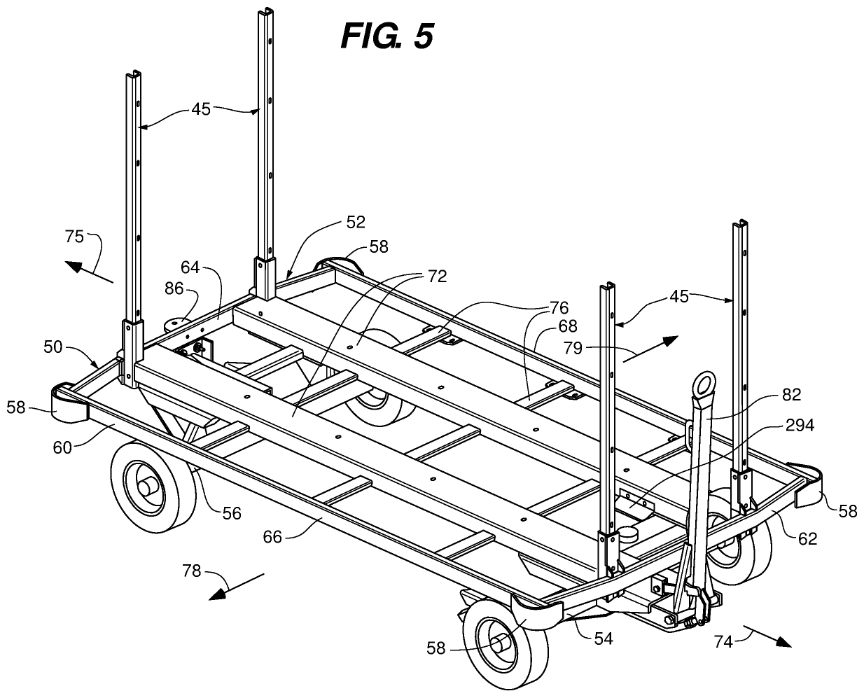

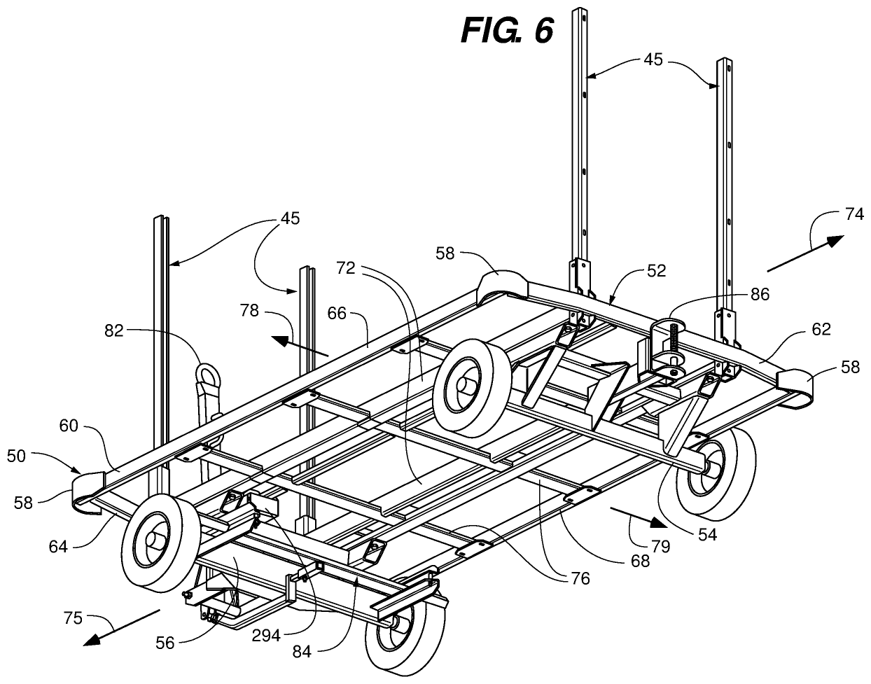

Referring to FIGS. 5 and 6, the running gear assembly 50 is depicted and described in more detail according to an embodiment of the disclosure. The running gear assembly 50 includes a framework 52 that is supported by a forward wheel assembly 54 and a rearward wheel assembly 56. The framework 52 may include bumpers 58 that cover corners of the framework 52. The framework 52 includes an outer frame 60 having a fore and aft members 62 and 64 separated by lateral members 66 and 68. The outer frame 60 surrounds and supports a plurality of stringers 72 extending in forward and rearward directions 74 and 75, and a plurality of cross members 76 extending in first and second lateral directions 78 and 79. The forward wheel assembly 54 is pivotally coupled to the framework 52 and includes a tow bar 82 and a brake assembly 84. In some embodiments, lifting of the tow bar 82 into an upright position actuates the brake assembly 84, causing the brake assembly 84 to engage the tires of the forward wheel assembly 64. The rear wheel assembly 76 may include a hitch 86. The uprights 45 extend upward from the running gear assembly 50 proximate the fore and aft members 62 and 64.

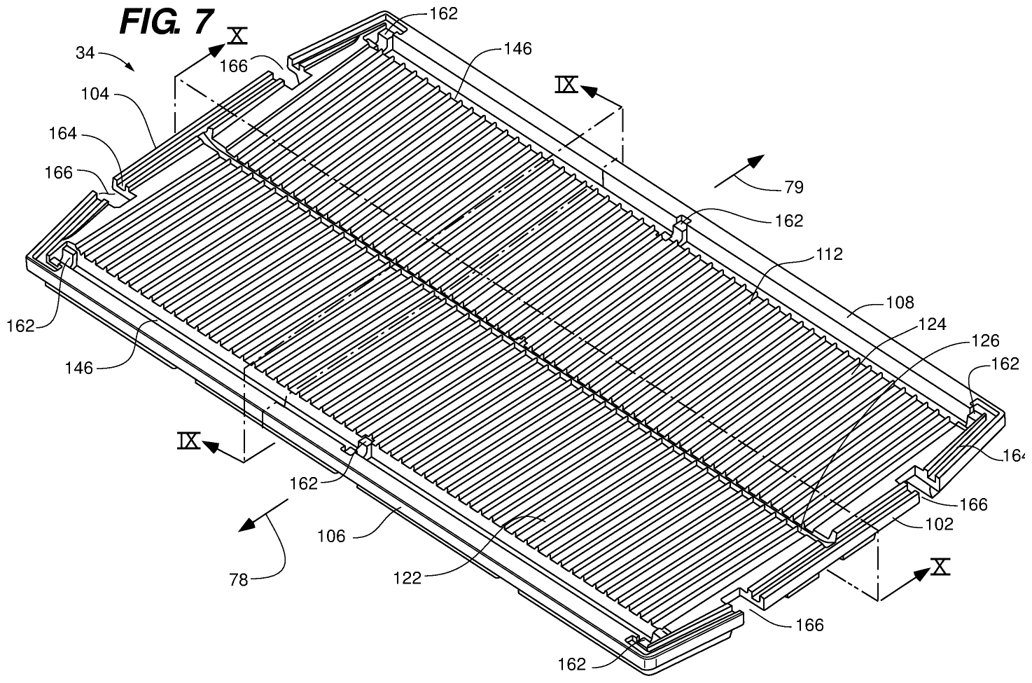

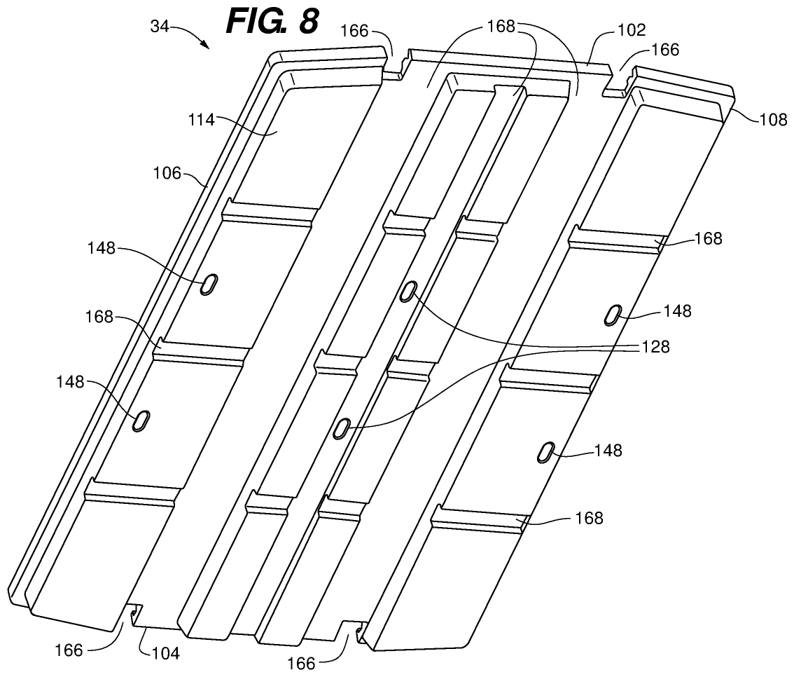

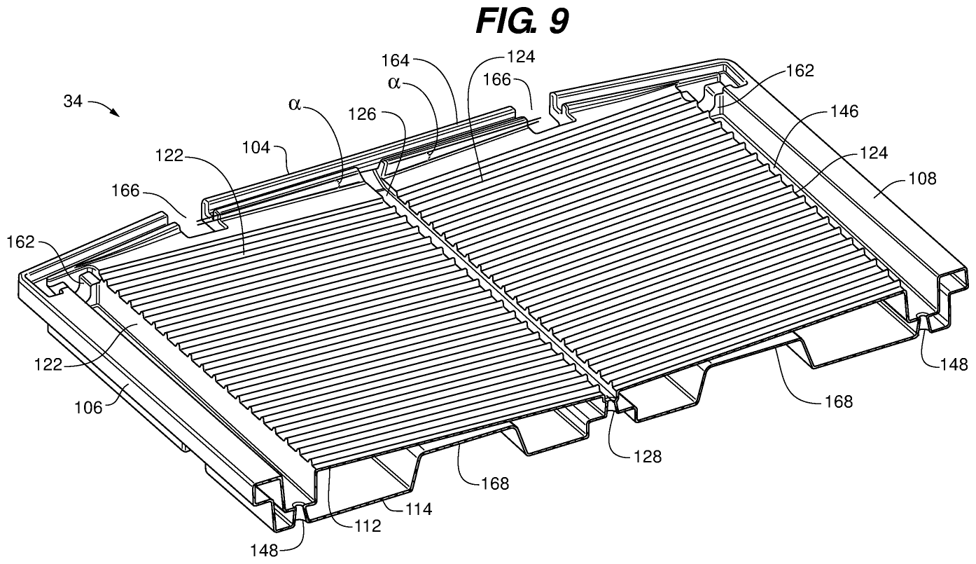

Referring to FIGS. 7 through 11, the floor 34 is depicted in more detail according to an embodiment of the disclosure, The floor 34 is generally rectangular, having forward and rearward end portions 102 and 104, first and second lateral edge portions 106, 108, and upper and lower panels 112 and 114. The upper panel 112 may include a first lateral portion 122 and a second lateral portion 124 separated by a relief portion 126. In some embodiments, the relief portion 126 extends from proximate the forward end portion 102 to proximate the rearward end portion 104. The first lateral portion 122 of the upper panel 112 extends from the relief portion 126 to the first lateral edge portion 106 of the floor 34 in the first lateral direction 78. The second lateral portion 124 of the upper panel 112 extends from the relief portion 126 to the second lateral edge portion 108 of the floor 34 in the second lateral direction 79, the second lateral direction 79 being opposite the first lateral direction 78.

In some embodiments, the first and second lateral portions 122 and 124 of the upper panel 112 of the floor 34 each define an inclined angle a relative to the co-plane of the opposed coplanar first and second lateral edge portions 122 and 124, the inclined angle a sloping downward toward the relief portion 126 in the lateral directions 78, 79, with the relief portion 126 extending below the first and second lateral portions 122 and 124. In some embodiments, the floor 34 defines one or more drain holes 128 that passes through the relief portion 126. In the depicted embodiments, the lateral portions 122 and 124 of the upper panel 112 each define a plurality of ribs 142 and grooves 144 that extend parallel to each other and extend laterally from the relief portion 126. The upper panel 112 may further define gutters 146 proximate and extending below the lateral edge portions 106 and 108. In some embodiments, each gutter 146 defines at least one drain hole 148. In some embodiments, the gutters 146 further define mounting features 162 for mounting of the curtain assembly 48.

In some embodiments, the upper panel 112 at the forward and rearward end portions 102. and 104 define contoured receptacles 164 that extend from the first lateral edge portion 106 to the second lateral edge portion 108. The forward and rearward end portions 102 and 104 of the floor 34 may define notches 166 that accommodate passage of the uprights 45, and which may interrupt the receptacles 164. In some embodiments, the lower panel 114 of the floor 34 defines recesses 168 that conform to the stringers 72 and cross members 76 of the running gear assembly 50.

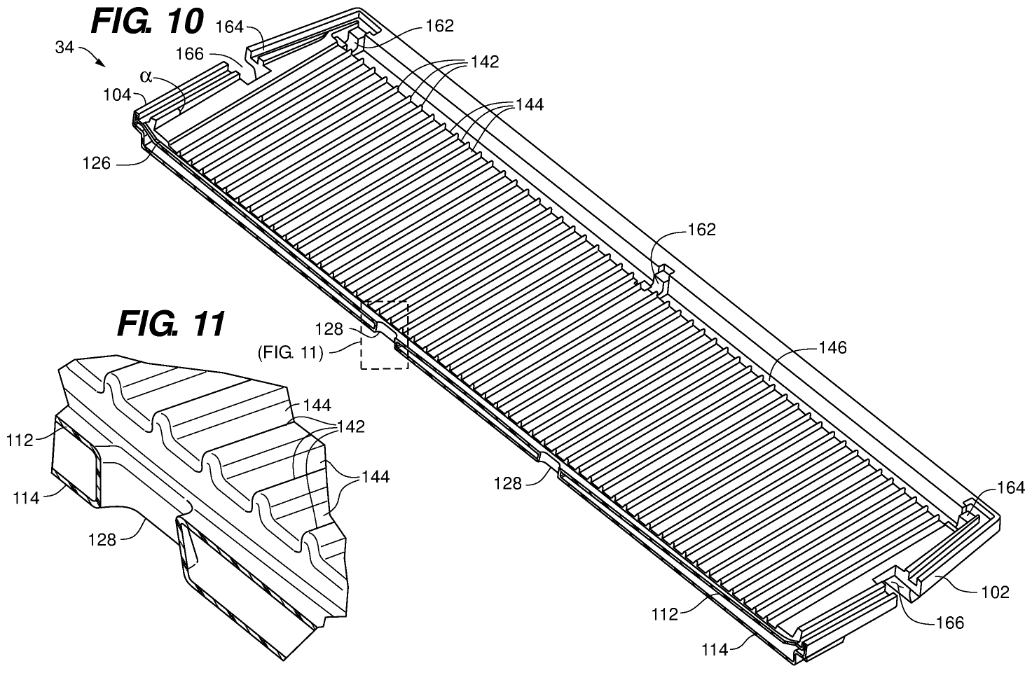

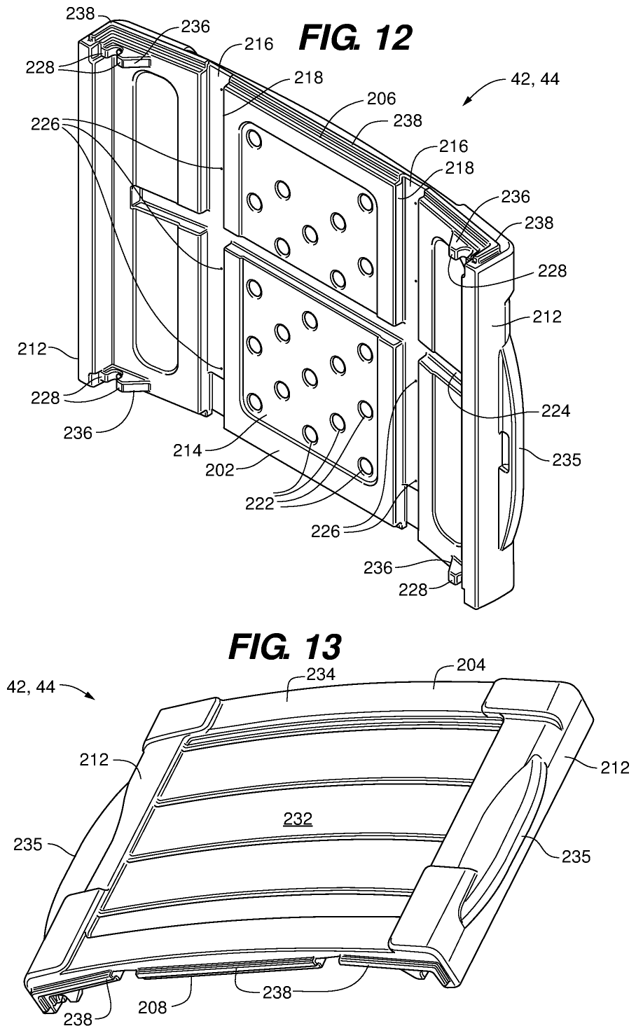

Referring to FIGS. 12 and 13, the end walls 42, 44 are depicted according to an embodiment of the disclosure. The end walls 42, 44 may be identical and may be formed from a common mold. In some embodiments, each end wall 42, 44 includes an inner panel 202 and an outer panel 204 that merge along a top edge portion 206, a bottom edge portion 208, and side column portions 212. The inner panel 202. may define an inner central portion 214 and a pair of vertical channels 216, the vertical channels 216 bounding lateral edges 218 of the inner central portion 214 and being located, shaped, and dimensioned to accept the uprights 45 that extend from the running gear assembly 50. In some embodiments, the inner central portion 214 defines a plurality of separation cones 222 that extend toward the outer panel 204. In some embodiments, the inner panel 202 defines a laterally extending shelf support channel 224 that extends substantially parallel to the top and bottom edge portions 206 and 208, and may extend across the inner central portion 214 and at least partially onto the column portions 212. In some embodiments, the end walls 42, 44 define fastening points 22.6 along the vertical channels 216 for mounting of the uprights 45 to the end wall 42, 44 with fasteners. Fastening points 228 may also be defined in the mounting features 162, 236 for mounting the curtain assembly 48. In some embodiments, the fastening points 226, 228 are fitted with rivet nuts that accept the fasteners.

The outer panel 204 defines an outer central portion 232 which may be inset from a raised face portion 234. In some embodiments, the outer panel 204 defines handle portions 235 that extend laterally from the column portions 212. In some embodiments, the inner and outer panels 202 and 204 cooperate to define the column portions 212. The inner panel 202 at the column portions 212 may define mounting features 236 for securing the curtain assembly 48. The inner and outer panels 202 and 204 may further cooperate to define protuberances 238 that protrude from the top and bottom edge portions 206 and 208 of the end wall 42, 44, the protuberances 238 being dimensioned to mate with the receptacles 164 at the forward and rearward end portions 102 and 104 of the floor 34.

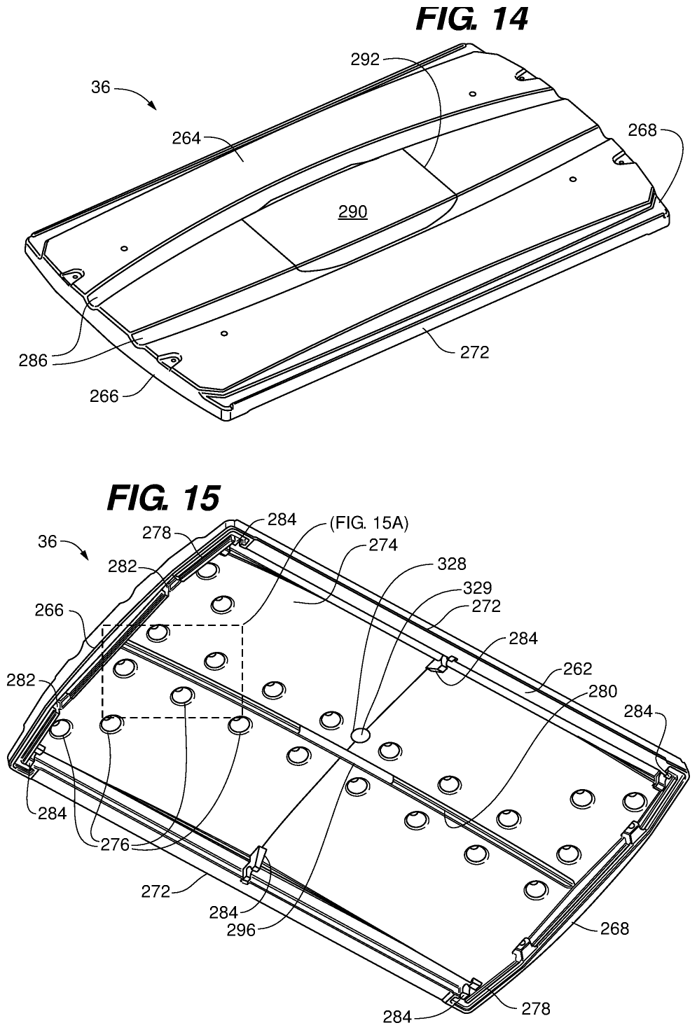

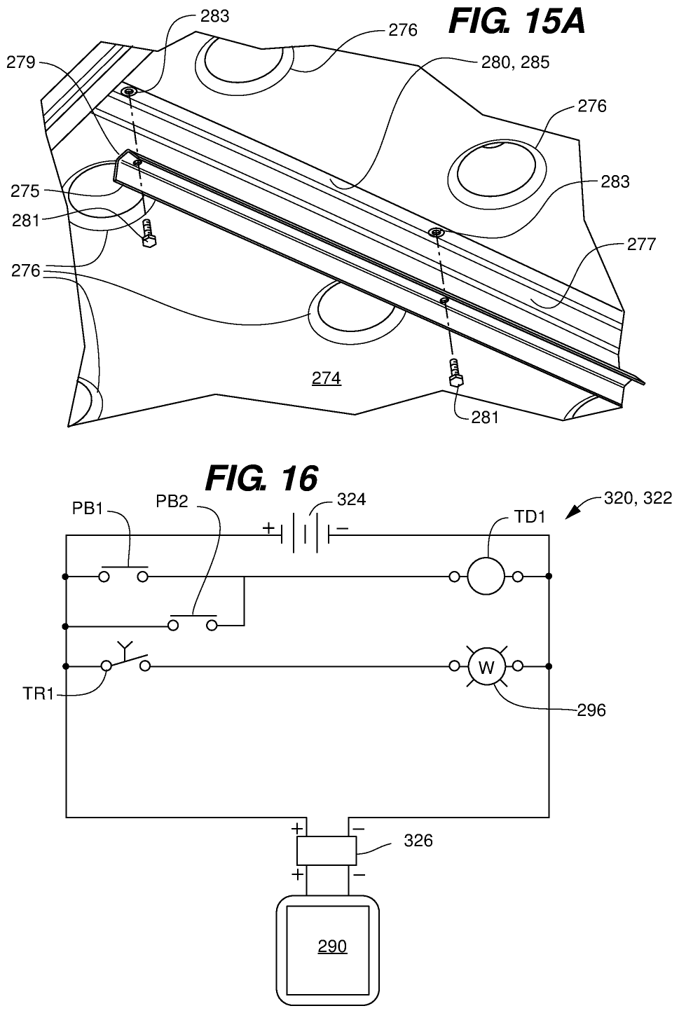

Referring to FIGS. 14, 15, and 15A, the roof 36 is depicted in greater detail according to an embodiment of the disclosure. The roof 36 includes an interior panel 262. and an exterior panel 264 that merge along a forward edge portion 266, a rearward edge portion 268, and lateral edge portions 272. The interior panel 262 includes a ceiling portion 274 that may be framed by and recessed relative to the forward, rearward, and lateral edge portions 266, 268, and 272. In some embodiments, the ceiling portion 274 includes a plurality of separation cones 276 and a ceiling rib 280 that extend toward the exterior panel 264. The ceiling rib 280 may extend longitudinally along the ceiling portion 274 from proximate the forward edge portion 266 to proximate the rearward edge portion 268.

In some embodiments, a structural channel 275 is disposed within the ceiling rib 280. The ceiling rib 280 defines a ceiling recess 277 that complements the cross-sectional shape of the structural channel 275 to fit the upper profile 279 of the structural channel 275. In some embodiments, the structural channel 275 is fastened within the ceiling rib 280 with fasteners 281 that mate with rivet nuts 283, the rivet nuts 283 being affixed to the ceiling portion 274 at a crown 285 of the ceiling rib 280 (FIG. 15A). The structural channel may be fabricated from a composite or resin material, or from a metal such as aluminum or stainless steel.

The interior panel 262 at the forward and rearward edge portions 266 and 268 may define receptacles 278 that are shaped and dimensioned to accept the protuberances 238 along the top edge portions of the end walls 42 and 44, and also sockets 282 dimensioned and shaped to accept the top ends of the uprights 45. In some embodiments, the interior panel 262 includes mounting features 284 at or proximate the lateral edge portions 266, 268 for mounting of the curtain assembly 48. The exterior panel 264 may he generally convex. In some embodiments, the exterior panel 264 defines gutter ways 286.

In some embodiments, a solar panel 290 is positioned on the exterior panel 264 of the roof 36. The exterior panel 264 may define an exterior recess 292 shaped and dimensioned to receive the solar panel 290. In some embodiments, the solar panel 290 is wired to store electrical energy in a battery that is stowed in a caddy 294 mounted to the running gear assembly 50 (FIGS. 5 and 6). The battery may be electrically coupled to a light emitter 296, for example an LED light array. In some embodiments, the light emitter 296 is mounted to the ceiling portion 274 of the interior panel 262 of the roof 36 within the ceiling rib 280 (depicted). In some embodiments, the light emitter 296 is mounted on the exterior panel 264, for example to backlight signage disposed on the roof 36. In some embodiments, the light emitter 296 is sized in a range of one to two watts inclusive. Herein, a range that is said to be “inclusive” includes that stated end points of the range as well as all values between the end points.

Referring to FIG. 16, an electrical schematic 322 of a lighting system 320 is depicted according to an embodiment of the disclosure. The lighting system 320 includes the solar panel 290 wired to a battery 324 via a battery tender 326. The battery tender 326 aids in the charging of the battery 324, protecting the battery 324 from overcharging and isolating the battery 324 from the solar panel 290. A timer TD1 is activated by the battery 324 by depressing any one of a plurality of push button switches PB1, PB2. A timer relay TR1 is closed by the timer TD1 to activate the light emitter 296. In the depicted embodiment, the timer TD1 is internally sourced by the timer relay TRI for the time interval of the timer TD1. In some embodiments, the timer TDI is adjustable, providing an energization period to the lighting system 320 within a range of time (e.g., in a range of five to 30 minutes). When the light emitter 296 is not in service, the solar panel 290 passively charges the battery 324 when the solar panel 290 is exposed to ambient light. The battery 324 may be a deep cycle battery, having a voltage, for example, of six or 12 volts. In some embodiments, the solar panel 290 is sized in a power range of five to 20 watts inclusive.

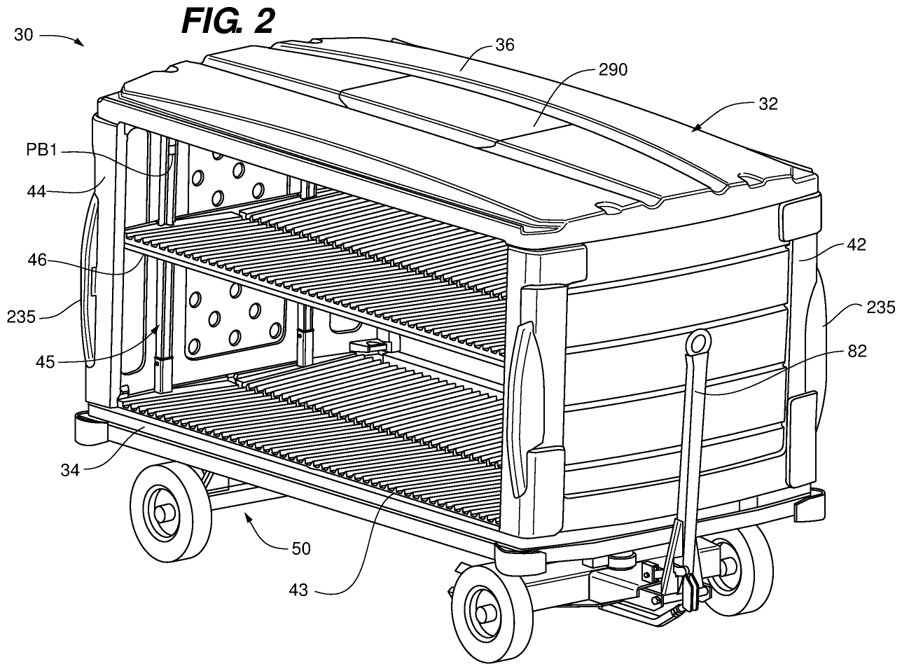

Physically, the battery 324 may be stored in the caddy 294 mounted to the running gear assembly 50, with wiring being routed from the solar panel 290, through the uprights 45 and along the framework 52 of the running gear assembly 50 to the caddy 294. The push button switches PB1, PB2 may be mounted to the uprights 45, one accessible from a corresponding side of the luggage cart 30 (FIGS. 2 through 4). In some embodiments, various electronics associated with the lighting system 320 (e.g., battery tender 326, timer TD1, timer relay TR1) are housed in the roof 36, accessible through a port 328 and cover 329 (FIG. 15).

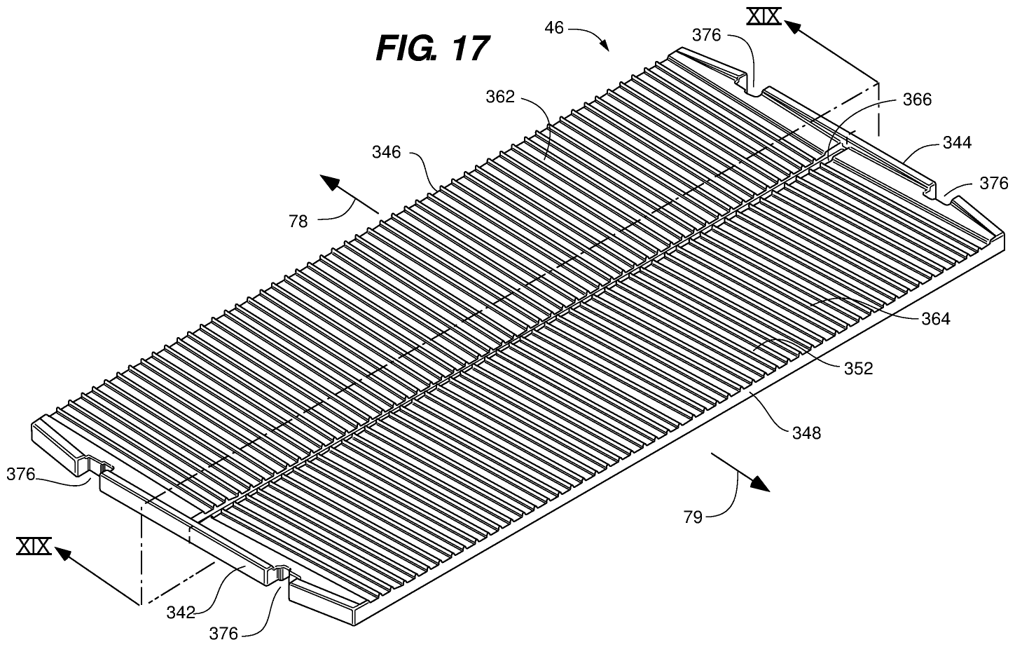

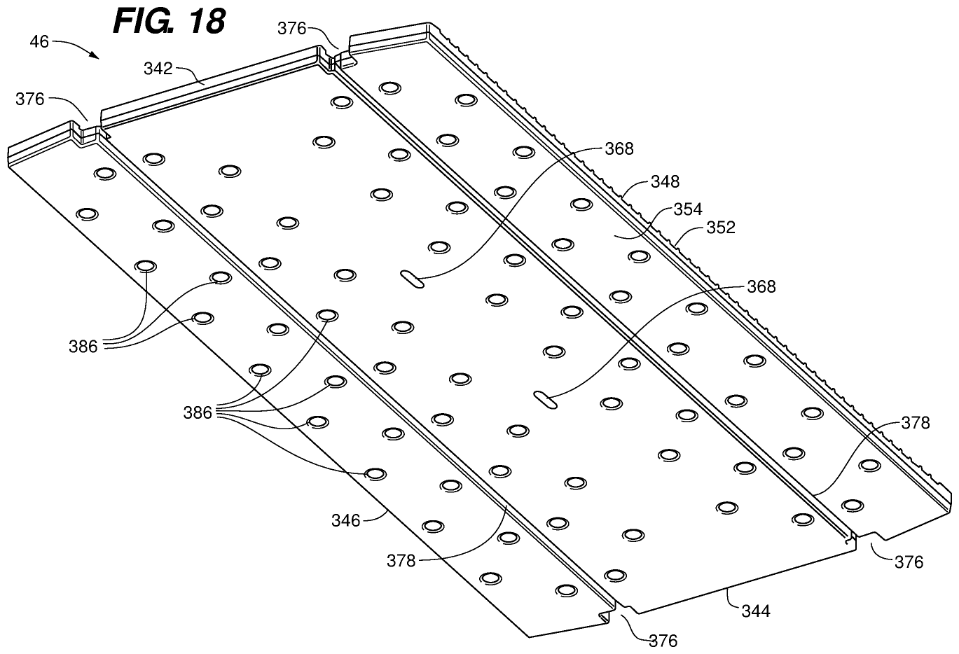

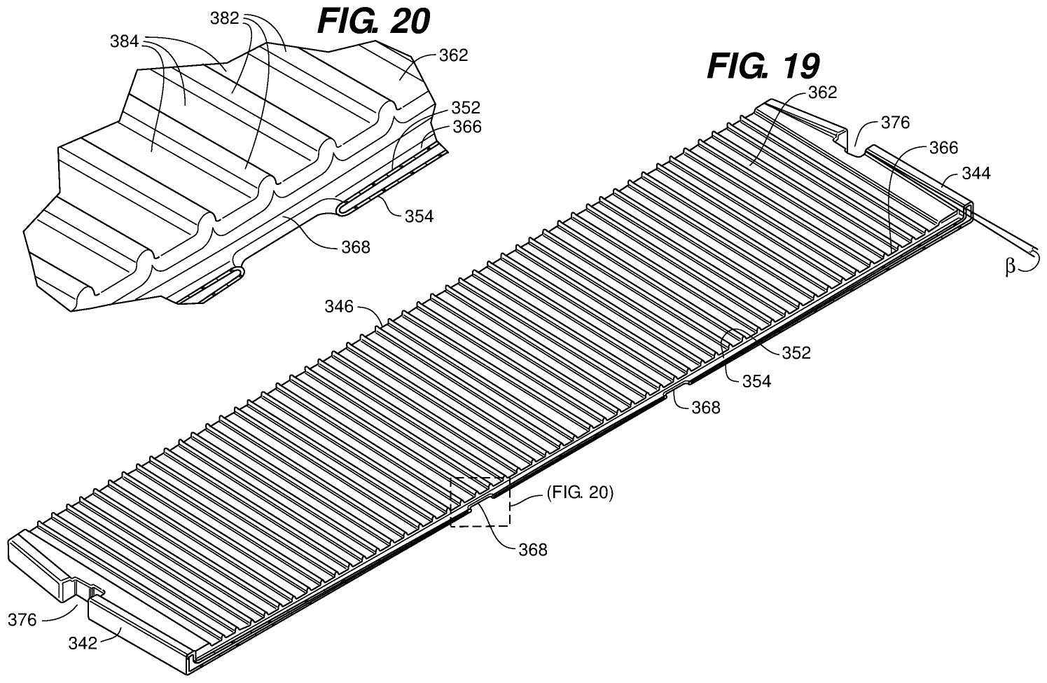

Referring to FIGS. 17 through 20, the shelf 46 is depicted in more detail according to an embodiment of the disclosure. The shelf 46 is generally rectangular, having forward and rearward end portions 342 and 344, opposed first and second lateral edge portions 346, 348 that are coplanar, and upper and lower panels 352 and 354. The upper panel 352 may include a first lateral portion 362 and a second lateral portion 364 separated by a relief portion 366. In some embodiments, the relief portion 366 extends from proximate the forward end portion 342 to proximate the rearward end portion 344. The first lateral portion 362. of the upper panel 352 extends from the relief portion 366 to the first lateral edge portion 346 of the shelf 46 in the first lateral direction 78. The second lateral portion 364 of the upper panel 352 extends from the relief portion 366 to the second lateral edge portion 348 of the shelf 46 in the second lateral direction 79.

In some embodiments, the first and second lateral portions 362 and 364 of the upper panel 352 of the shelf 46 each define an inclined angle β relative to the co-plane of the opposed coplanar first and second lateral edge portions 362 and 364, the inclined angle 0 sloping downward toward the relief portion 366, with the relief portion 366 extending below the first and second lateral portions 362 and 364. In some embodiments, the shelf 46 defines one or more drain holes 368 that passes through the relief portion 366. In the depicted embodiments, the lateral portions 362 and 364 of the upper panel 352 each define a plurality of ribs 382 and grooves 384 that extend parallel to each other and extend laterally from the relief portion 366.

In some embodiments, the forward and rearward end portions 342 and 344 of the shelf 46 are contoured and sized to mate with the laterally extending shelf support channel 224 of the opposed end walls 42 and 44. The forward and rearward end portions 342 and 344 may also define notches 376 that accommodate passage of the uprights 45 of the running gear assembly 50. In some embodiments, the lower panel 354 of the shelf 46 defines recesses 378 that conform to the shelf stringers 47 that extend between the uprights 45 that are disposed on the opposed end walls 42 and 44. The lower panel 354 may also define a plurality of separation cones 386 that extend toward the upper panel 352.

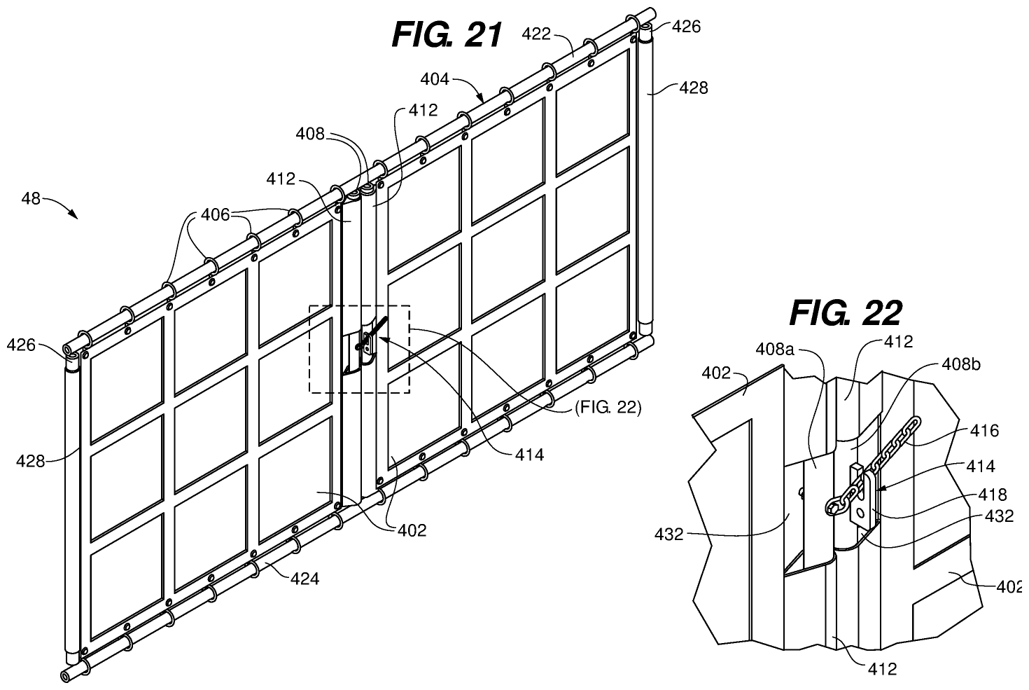

Referring to FIGS. 21 and 22, the curtain assembly 48 is depicted in more detail according to an embodiment of the disclosure. Each curtain assembly 48 includes at least one curtain or blind 402 that is slidingly coupled to a curtain support structure 404 with a plurality of curtain loops 406. In some embodiments, the curtain assembly 48 includes a stiffener member or members 408 coupled to a moving end or ends 412 of the curtain(s) 402. A clasping mechanism 414 may be coupled to the stiffener members) 408. In the depicted embodiment, the clasping mechanism includes a chain 416 attached to a first stiffener member 408a and a hook 418 attached to a second stiffener member 408b, the hook 418 being sized to capture a link of the chain 416 (FIG. 22).

The curtain support structure 404 includes an upper rod 422, along which the curtain loops 406 slide during opening and closing of the curtain 402. In some embodiments, the curtain support structure 404 includes a lower rod 424, also along which the curtain loops 406 slide during opening and closing of the curtain 402. The curtain support structure 404 may also include curtain support uprights 426, to which a fixed end or ends 428 of the curtain 402 is moored. In this way, the curtain support structure 404 may effectively frame the opening 43 of the polymer cabin 32. In the depicted embodiment, the fixed ends 428 of the curtain 402 is wrapped around the curtain uprights 426 to effect the mooring. Likewise, the moving ends 412 of the curtain 402 may be wrapped around the stiffener members 408 to capture and couple the stiffener members 408 to the curtain 402. The curtain uprights 426 may also function to provide separation of the upper and lower rods 422 and 424. In some embodiments, the curtain 402 defines notches 432 where the curtain 402 is wrapped around the stiffener members 408 for mounting of and access to the clasping mechanism 414.

While the depicted embodiment depicts the curtain assembly 48 as having a bifurcated curtains 402a and 402h that meet midway across the span of the curtain support structure 404 to provide closure of the cabin 32, a single curtain or blind 402 is also contemplated that extends the entire length of the curtain support structure 404, with the clasping mechanism 414 joining a single stiffener member 408 to the corresponding curtain support upright 426.

The rotomolded polymer components (e.g., the floor 34, roof 36, end walls 42 and 44, and shelf 46) may be fabricated from low density polyethylene (LDPE), high density polyethylene (HDPE), polypropylene (PP), cross-linked polyethylene (XLPE), as well as other materials available for custom rotomolding processes. High density polymers fare better in cold climates (down to −45 degrees Fahrenheit), being less prone to fracturing due to impact loads. Certain components of the luggage cart 30 are made of metal or other structural material of suitable strength, such as composites. For example, in some embodiments, the framework 52, uprights 45, or shelf stringers 47 include metal tubing or channel, such as steel, aluminum or composite tubing or channel. The gusset brackets 49 may be fabricated from flat metallic or composite stock. The bumpers 58 may be metallic, or alternatively of a semi-rigid material, such as hard rubber or polymers. The wheel assemblies 64, 76, curtain support structure 404 and curtain loops 406 may also be made primarily of metallic or composite components.

Functionally, the parallel ribs 142, 382 and grooves 144, 384 reduce contact with items that are placed on the floor 34 and the shelf 46. When removing items from the cabin 32, the reduced contact with the items, as well as the low frictional properties of polymers generally, reduces the drag on the items relative to flat metallic surfaces. The downward and inward inclined angles α and β of the upper panels 112 and 352 of the floor 34 and the shelf 46, respectively, helps contain transported items within the luggage cart 30. That is, as items vibrate and shift during transport, the transported items tend to slide down the inclined angles α and β, toward the center of the luggage cart 30. Furthermore, the inclined angles α and β help channel any precipitation that may be incident on the floor 34 or shelf 46 toward the relief portions 126 and 366 and through the drain holes 128 and 368, thereby preventing pooling of precipitation. The parallel ribs 142, 382 may further act to suspend any items that are present over the draining precipitation, while the grooves 144, 384 act to drain the precipitation underneath the items and into the relief portions 126 and 366.

The separation cones 222, 276, 386 and ceiling rib 280 maintain a separation between the panels 202, 274, 354 and the panels 204, 264, 352, respectively. The structural channel 275 provides strength to the longitudinal span of the roof 36, and acts to spread any concentrated load that may occur on the roof 36. The gutter ways 286 facilitate the drainage of precipitation away from the solar panel 290. The recesses 378 enable the shelf stringers 47 to be mounted flush with or recessed relative to the lower panel 354 of the shelf 46. The combination of the tow bar 182 and the hitch 184 enables several of the luggage carts 30 to be strung together in a train formation. The protuberances 238 inserted into the mating receptacles 164 provide strength at the coupling joint between the end walls 42, 44 and the floor 34 and roof 36, and provides rigidity to the polymer cabin 32. Likewise, the coupling of the forward and rearward end portions 342 and 344 of the shelf 46 and the laterally extending shelf support channels 224 of the end walls 42 and 44 provides additional strength at the joint between the shelf 46 and the end walls 42 and 44, as well as providing additional rigidity to the polymer cabin 32.

The timer TD1 of the lighting system 320 enables temporary lighting of the luggage cart 30 without requiring personnel to remember to shut off the lighting. This conserves the energy from the solar panel 290 that is stored to the battery 324 to mitigate unnecessary drainage of the battery 324 due to inadvertently leaving the lighting system 320 energized.

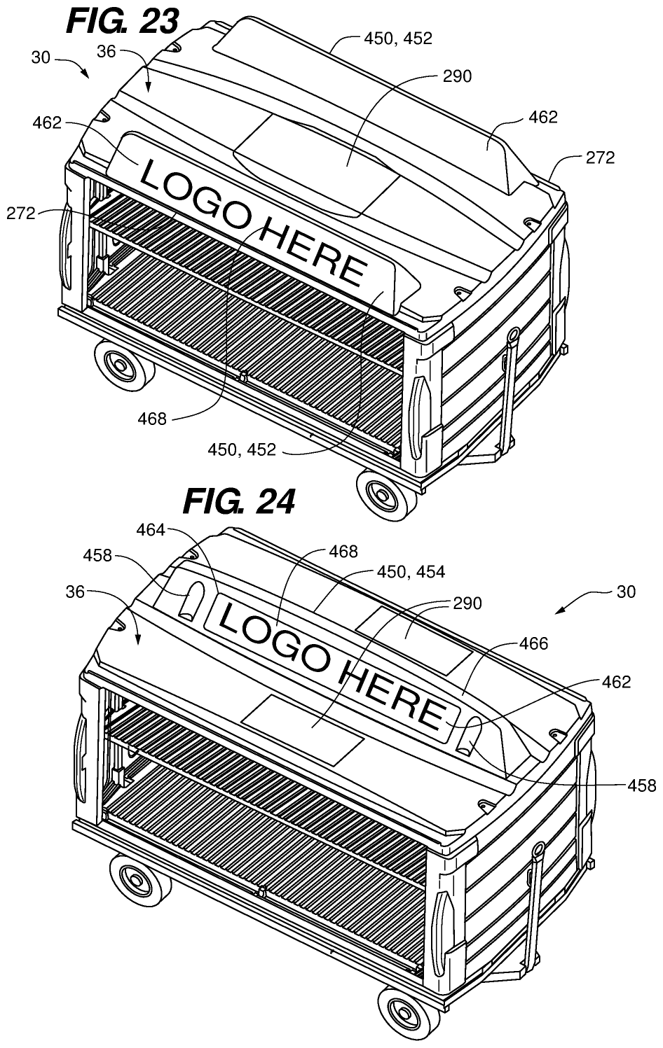

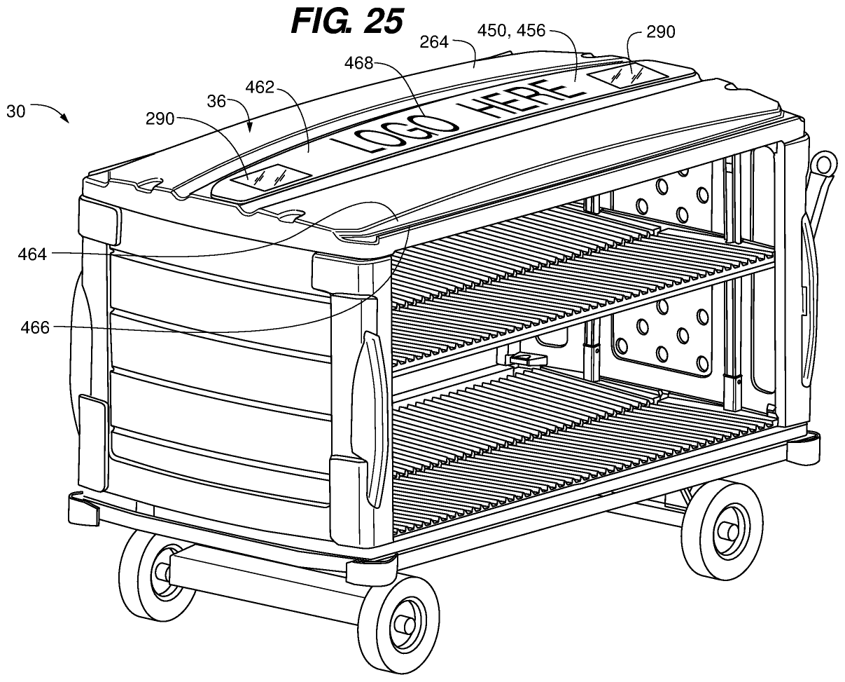

Referring to FIGS. 23 through 26, backlit panels 450 mounted to the roof 36 for brand logos or advertising are depicted according to embodiments of the disclosure. In some embodiments, the backlit panels 450 are upright edge billboards 452 positioned proximate the lateral edge portions 272 of the roof 36 (FIG. 23). In some embodiments, the backlit panel 450 is an upright center billboard 454 positioned at or near a center of the roof 36 (FIG. 24). In some embodiments, one or more exterior portions 456 of the low profile, exterior panel 264 of the roof 36 are configured as the backlit panel 450 (FIG. 25). The backlit panels 450 may be integrally formed with the roof 36 (FIGS. 23 and 25) or be separate structures that are attached to the roof 36 at fastener pockets 458 (FIG. 24). In some embodiments, the backlit panel 450 is formed entirely of a translucent material 462 (FIG. 23). In some embodiments, only a portion 464 of the backlit panel 450 is translucent, the portion 464 being bordered by a material 466 that is opaque or of reduced translucence relative to the translucent material 462 (FIG. 24), In some embodiments, a logo or message 468 is presented on the backlit panel 450. The logo or message 468 may be permanently inscribed on the backlit panel 450, or may be in the form of removable, transparent or semi-transparent signage, for example by adhesion or fastening to the backlit panel 450. The translucent materials may be fabricated from low density polyethylene (LDPE), high density polyethylene (HDPE), polypropylene (PP), cross-linked polyethylene (XLPE), as well as other materials formulated for translucent effect.

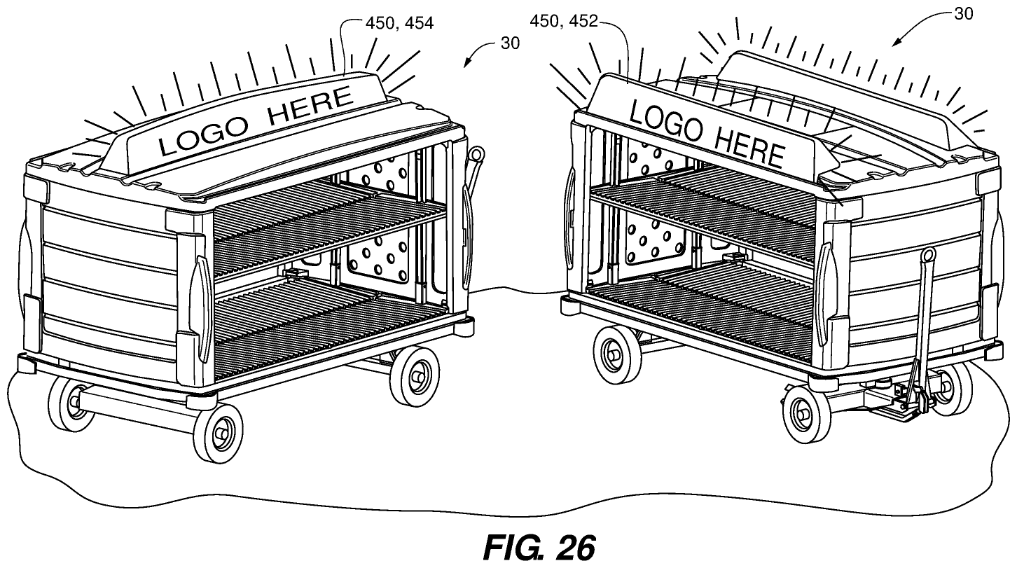

In some embodiments, the lighting system 320 is modified or reconfigured so that the light emitter 296 backlights the backlit panel 450. In some embodiments, a second lighting system akin to the lighting system 320 is provided to supply backlighting to the backlit panel 450. The effect is illustrated in FIG. 26. During periods of ambient dusk or darkness, the backlit panels 450 illuminate relative to the surroundings and stand out, creating a standout effect favorable to advertising. The upright billboards 452, 454 can be seen over a wide altitude angle (i.e., both from the ground and above ground). The low profile backlit exterior portion 456 can be seen from above, for example, by passengers seated in an airliner that is being serviced by the luggage cart 30.

The solar panels 290 may be configured to accommodate the positioning of the backlit panel 450. The centrally located solar panel 290 of FIG. 1 is suitable for the upright edge billboards 452 of FIG. 23. For the upright center billboard 454, the solar panels 290 may be disposed on either or both sides of the billboard 454 (FIG. 24). For the low profile backlit exterior portion 456 of the exterior panel 264 of the roof 36, the solar panels 290 may be disposed at the ends of the center portion of the roof 36 (FIG. 25), or on either or both sides of the center portion, akin to FIG. 24.

In some embodiments, baggage handling personnel can be instructed to energize the backlit panel 450 (described attendant to FIG. 16) by depressing one of the push button switches PB1, PB2, thereby activating the lighting system 320 or counterpart lighting system configured to backlight the backlit panel 450. The baggage handling personnel pull up to the airliner and position the luggage cart 30 for loading or offloading of luggage. The backlit panel 450 is energized by the baggage handling personnel and may remain illuminated for part or all of the duration of the servicing of the airliner. Backlighting of the backlit panel 450 ceases upon expiration of the time period set by the timer TD1 . In this way, clientele that frequently fly into a given location can be targeted advertising posted on the backlit panel 450. For example, hotels may use the backlit panel 450 for advertising in target business destinations, while attractions such as zoos, aquariums, and theme parks may use the backlit panel 450 to advertise in tourist destinations. While the above discussion is directed to use with luggage carts 30 on airport tarmacs, the same concept may be implemented at railway stations and bus depots.

Each of the additional figures and methods disclosed herein can be used separately, or in conjunction with other features and methods, to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant arts will recognize that the various features described for the different embodiments can be suitably combined, un-combined, and re-combined with other features, alone, or in different combinations. Likewise, the various features described above should all be regarded as example embodiments, rather than limitations to the scope or spirit of the disclosure.

Persons of ordinary skill in the relevant arts will recognize that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art.

Any incorporation by reference of documents above is limited such that no subject matter is incorporated that is contrary to the explicit disclosure herein, Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

Unless indicated otherwise, references to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112(f) are not to be invoked unless the specific terms “means for” or “step for” are recited in the respective claim.

1-18. (canceled)

19. A baggage cart for transporting items between airport terminals and aircraft, comprising:
a running gear assembly including rotatable forward wheel assembly operatively coupled to a tow bar, a rearward wheel assembly, and a rearward hitch; and
a polymer cabin supported by said running gear, said polymer cabin including a floor and a roof separated by a forward end wall and a rearward end wall, said floor including an upper panel having a first lateral portion and a second lateral portion separated by a relief portion, said relief portion extending from proximate said forward end wall to proximate said rearward end wall, said first lateral portion of said upper panel of said floor extending from said relief portion to a first lateral edge portion of said floor in a first lateral direction, said second lateral portion of said upper panel of said floor extending from said relief portion to a second lateral edge portion of said floor in a second lateral direction, said second lateral direction being opposite said first lateral direction, said first lateral portion of said upper panel of said floor sloping downward toward said relief portion, said second lateral portion of said upper panel of said floor sloping downward toward said relief portion, said relief portion extending below said first lateral portion and said second lateral portion of said upper panel of said floor, said relief portion at least partially defining a drain hole,
wherein.
said first lateral portion of said upper panel of said floor defines a plurality of ribs and grooves that extend parallel to each other from said relief portion in said first lateral direction;
said second lateral portion of said upper panel of said floor defines a plurality of ribs and grooves that extend parallel to each other from said relief portion in said second lateral direction;
said first lateral portion of said upper panel of said floor defines a first gutter that extends adjacent and parallel to said first lateral edge portion of said floor from proximate said forward end wall to proximate said rearward end wall;
said second lateral portion of said upper panel of said floor defines a second gutter that extends adjacent and parallel to said second lateral edge portion of said floor from proximate said forward end wall to proximate said rearward end wall.

20. The baggage cart of claim 19, wherein each of said first gutter and said second gutter defines at least one drain hole that extends downward therethrough.

21. The baggage cart of claim 20, wherein said upper panel defines a plurality of mounting features that extend upward within each of said first gutter and said second gutter, each of said mounting features configured to secure a lower rod of a curtain assembly.

22. The baggage cart of claim 21, comprising:
a shelf suspended above said floor, said shelf extending from said forward end wall to said rearward end wall, said shelf including an upper panel having a first lateral portion and a second lateral portion separated by a relief portion, said relief portion extending from proximate said forward end wall to proximate said rearward end wall, said first lateral portion of said upper panel of said shelf extending from said relief portion to a first lateral edge portion of said shelf in said first lateral direction, said second lateral portion of said upper panel of said shelf extending from said relief portion to a second lateral edge portion of said shelf in said second lateral direction, said first lateral portion of said upper panel of said shelf sloping downward toward said relief portion, said second lateral portion of said upper panel of said shelf sloping downward toward said relief portion, said relief portion extending below said first lateral portion and said second lateral portion of said upper panel of said shelf, said relief portion at least partially defining a drain hole, wherein:.
said first lateral portion of said upper panel of said shelf defines a plurality of ribs and grooves that extend parallel to each other from said relief in said first lateral direction; and
said second lateral portion of said upper panel of said shelf defines a plurality of ribs and grooves that extend parallel to each other from said relief in said second lateral direction.

23. The baggage cart of claim 22, comprising a pair of uprights that extend upward from said running gear assembly, wherein said forward end wall and said rearward end wall are of identical construction, each including an inner panel and an outer panel that merge along a top edge portion, a bottom edge portion, and opposed side column portions, said inner panel including an inner central portion bounded laterally by a pair of vertical channels, said vertical channels being configured to accept said uprights, said uprights being coupled to said inner panel.

24. The baggage cart of claim 23, wherein each vertical channel of each of said pair of vertical channels define a plurality of fastening points, each fastening point being fitted with hardware for accepting a fastener.

25. The baggage cart of claim 23, wherein:
said upper edge portion defines an upper protuberance that mates with a receptacle defined on said roof, said upper protuberance extending continuously from a first of said opposed side column portions to a second of said opposed side column portions except for gaps defined at said pair of vertical channels; and
said lower edge portion defines a lower protuberance that mates with a receptacle defined on said floor, said lower protuberance extending continuously from said first of said opposed side column portions to said second of said opposed side column portions except for gaps defined at said pair of vertical channels.

26. The baggage cart of claim 25, wherein said inner panel defines a laterally extending shelf support channel, said shelf being disposed in said laterally extending shelf support channel.

27. The baggage cart of claim 25, wherein said inner central portion of said inner panel is defines a plurality of separation cones that extend outward to proximate said outer panel.

28. The baggage cart of claim 25, wherein said inner panel at each of said opposed column portions defines mounting features configured for mounting a curtain assembly thereto.

29. The baggage cart of claim 25, wherein said outer panel includes a pair of handle portions, one at each of said opposed column portions.

30. The baggage cart of claim 25, wherein said roof includes an interior panel and an exterior panel that merge along a forward edge portion, a rearward edge portion, and opposed lateral edge portions, said interior panel including a plurality of separation cones that extend upward to proximate said exterior panel, said interior panel defining the receptacles of the upper protuberances of said forward end wall and said rearward end wall.

31. The baggage cart of claim 30, comprising a plurality of uprights that extend upward from said running gear, wherein said interior panel defines a plurality of sockets, each of said plurality sockets being aligned with a corresponding vertical channel defined on the interior panels of said forward end wall and said rearward end wall, each said plurality of sockets and corresponding vertical channel receiving a corresponding one of said plurality of uprights.

32. The baggage cart of claim 30, wherein said interior panel includes mounting features proximate said opposed lateral edge portions configured for mounting of said curtain assembly thereto.

33. The baggage cart of claim 30, comprising a lighting system including a solar panel connected to a battery via a battery tender, said battery being in selective communication with a timer and a light emitter via a push button switch, said timer being configured to energize said light emitter for a selected interval of time that is initiated by activating said push button switch, said solar panel being mounted to said roof, said push button switch being mounted inside said polymer cabin and accessible from outside said polymer cabin.

34. The baggage cart of claim 33, comprising a backlit panel coupled to said exterior panel of said roof, said backlit panel including a translucent material, said light emitter of said lighting system configured to backlight said backlit panel.

35. The baggage cart of claim 34, wherein said backlit panel is contoured to follow a profile of said exterior panel of said roof, said profile being generally convex.

36. The baggage cart of claim 35, wherein said exterior panel of said roof defines a gutterway that extends adjacent said solar panel.

37. The baggage cart of claim 31, wherein said floor defines a plurality of notches, each being in alignment with one of the corresponding vertical channels defined on the interior panels of said forward end wall and said rearward end wall and receiving said corresponding one of said plurality of uprights.

38. The baggage cart of claim 37, wherein said floor includes a lower panel suspended from said upper panel, said lower panel defining recesses that conform to stringers and cross members of said running gear assembly.
